(19) United States
(12) Patent Application Publication
(10) Pub. No.: US 2024/0074553 A1
(43) Pub. Date: Mar. 7, 2024

(54) PROCESS FOR PRODUCING A HOROLOGICAL OR JEWELLERY ELEMENT INLAID WITH A CERAMIC DECORATION

(71) Applicant: Comadur SA, Le Locle (CH)

(72) Inventors: Pierry VUILLE, Les Emibois (CH); Nicolas OIAN, Grimisuat (CH)

(73) Assignee: Comadur SA, Le Locle (CH)

(21) Appl. No.: 18/453,361

(22) Filed: Aug. 22, 2023

(30) Foreign Application Priority Data
Sep. 2, 2022 (EP) 22193760.0

(51) Int. Cl. A44C 27/00; A44C 25/00; B33Y 10/00; B33Y 70/10; B33Y 80/00

(52) U.S. Cl. CPC A44C 27/001; A44C 25/00; B33Y 10/00; B33Y 70/10; B33Y 80/00

(57) ABSTRACT

An aspect of the invention relates to a process for manufacturing a horological or jewellery external part element, including a body made of hard material, inlaid with a decoration made of a second material, where in a first step the body made of the hard material is formed, during this first step or in a second step, a hollow is produced in a face of the body, in a third step, the surface condition of the bottom and/or walls of said hollow is modified to increase the contact area thereof, in a fourth step, this hollow is filled with the second material is a composite material including at least one bio-sourced charged polymer including at least one bio-sourced charged polymer chosen for the wear resistance thereof, to constitute an insert forming a said decoration, in a fifth step, a surface finishing of said insert is performed.

### TECHNICAL FIELD OF THE INVENTION

The invention relates to a process for manufacturing a horological or jewellery element, made of hard material, inlaid with at least one decoration made of a second material.

The invention furthermore relates to a horological or jewellery external part element, made of hard material, inlaid with at least one decoration made of a second material.

The invention furthermore relates to a timepiece and piece of jewellery including at least one such external part element.

The invention relates to the field of the manufacture of external part elements for timepieces, or pieces of jewellery, which must combine a high mechanical strength, wear resistance, constancy, and a particular aesthetic effect.

### TECHNOLOGICAL BACKGROUND

Producing external part components based on a hard material, particularly and non-restrictively a ceramic, including a decoration contrasting with the appearance of this hard material, is difficult, as this decoration must have mechanical strength, wear resistance, and constancy qualities which are similar to those of the hard base material. Furthermore, the bonding between the hard material and this mounted decoration must be perfect, and aesthetic (such as a jewellery setting), or invisible to the user.

The prior art includes rubber overmoulding, filling of cavities with a lacquer, filling with other materials such as Hyceram® or Liquidmetal®, or others, particularly by two-component injection moulding.

The problem in respect of the choice of materials and definition of the procedure is that of ensuring good mechanical behaviour of the external part element, and in particular excellent bonding of the decoration in a body made of hard material, good scratch resistance, and good durability.

### SUMMARY OF THE INVENTION

The invention proposes to develop a process for producing a horological or jewellery element, made of hard material, inlaid with at least one decoration, particularly made of a second material different from this hard material, to ultimately combine a high mechanical strength, wear resistance, constancy, and a particular aesthetic effect.

To this end, the invention relates to a process for producing a horological or jewellery element, made of hard material, inlaid with at least one decoration made of a second material different from this hard material, according to claim 1.

The invention furthermore relates to a horological or jewellery external part element, made of hard material, inlaid with at least one decoration made of a second material.

The invention furthermore relates to a timepiece and piece of jewellery including at least one such external part element.

### BRIEF DESCRIPTION OF THE FIGURES

The aims, advantages and features of the invention will be understood better upon reading the following detailed description, with reference to the appended figures, wherein:

FIG. 1 is a flow chart showing the sequence of steps of implementation of the process according to the invention;

FIG. 2 illustrates, schematically, a timepiece, particularly a watch, including an external part element with a decoration, produced according to this process;

FIG. 3 represents a schematic partial sectional view of an external part element made of hard material, which includes a hollow for receiving a second material intended to form a decoration;

FIG. 4 represents, similarly to FIG. 3, the same element, wherein undercut profiles have been implemented on the walls, and cavities also bordered by undercut surfaces have been implemented on the bottom of the hollow; the dot and dash lines show the trajectories of the laser beams, passing through the hollow orifice, and capable of machining these undercut profiles and bonding surfaces;

FIG. 5 represents, similarly to FIG. 4, the same element, wherein a second material, which is a composite material including in part or in whole at least one bio-sourced charged polymer, has been inserted into the hollow;

FIG. 6 represents, similarly to FIG. 5, the same element, wherein the protruding portion of the second material, has been made flush with the top surface of the body made of hard material;

FIG. 7 represents, similarly to FIG. 6, another element, wherein two hollows have been produced on either side of a thin wall, in which the walls and the bottoms have been worked similarly to FIG. 4, these hollows have also been filled with the second material, and the protruding portion of the second material, in a first hollow has been made flush with the top surface of the body made of hard material, and in the second hollow has been machined in a hollow with respect to this top surface.

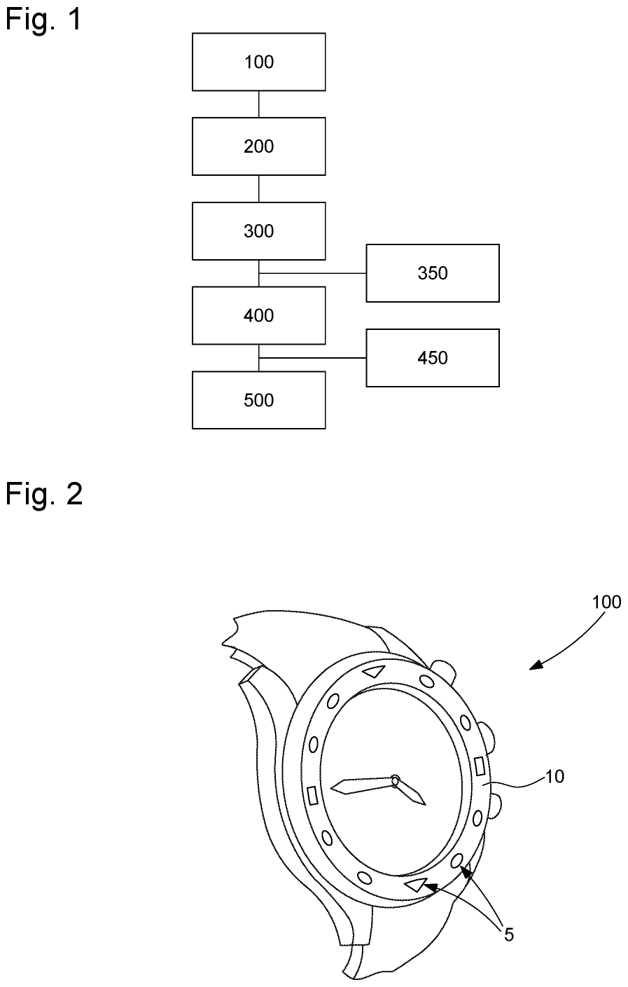

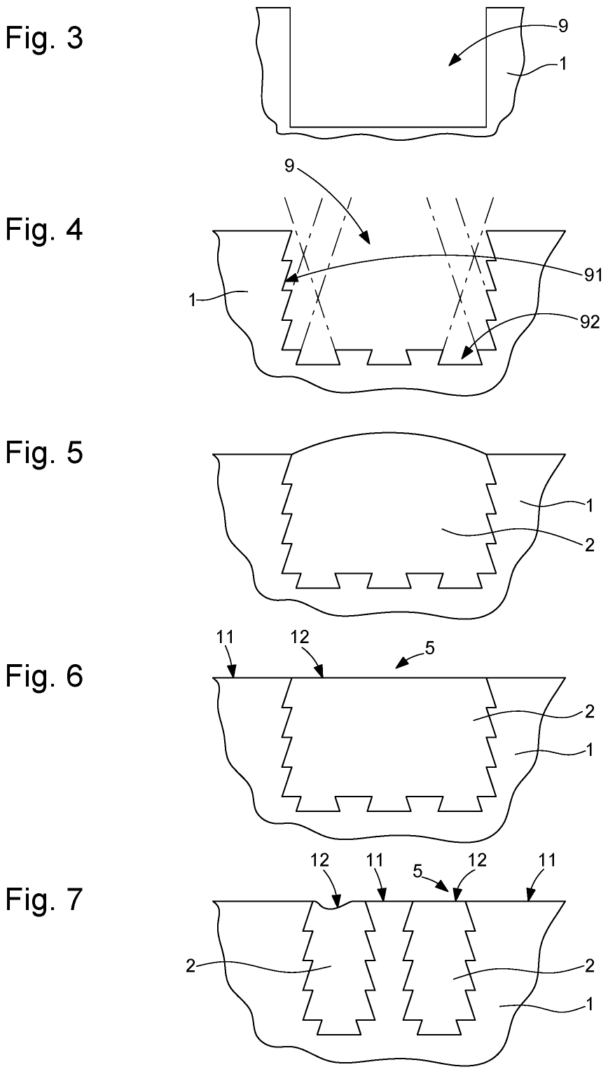

### DETAILED DESCRIPTION OF THE INVENTION

The invention relates to a process for manufacturing an element 10, particularly a horological or jewellery external part element, including a body made of hard material, inlaid with at least one decoration 5 made of a second material, particularly different from this hard material.

Since the introduction of ceramic material for the manufacture of horological or jewellery external parts, it is endeavoured to incorporate in these components decorations including digits, indexes, scales or display values, or aesthetic decorations.

The document EP2855400 held by The Swatch Group Research and Development Ltd thus describes a ceramic element inlaid with at least one composite ceramic decoration. This composite ceramic decoration is produced with an organic matrix charged with ceramic particles, crosslinked and densified in a controlled atmosphere after the insertion thereof in a hollow of the ceramic element. The teachings of this document are also applicable to certain variants of the present invention, for example for the manufacture of multicoloured decorations, or including a phosphorescent material such as Superluminova®, or including a phosphorescent strontium aluminate, or similar.

The document EP4001356 held by ETA SA Manufacture Horlogère Suisse describes an item made of a charged plastic material, this material comprising a filler made of a metallic and/or ceramic material, at least one polymer, and optionally a coupling agent, a reinforcement, a pigment, a diluent and/or a plasticising agent, in very specific ranges. Here again, the teachings of this document are also applicable to certain variants of the present invention, for example for the composition of a second material disclosed hereinafter.

According to the invention, in a first step 100, a body 1 made of such a hard material is formed.

During this first step 100, or in a second step 200 following this first step 100, at least one hollow 9 is produced in a face of the body 1 made of hard material. This at least one hollow 9 is arranged to form the impression of such a decoration.

In a third step 300, the surface condition of the bottom and/or the walls of this hollow 9 are modified to increase the contact area thereof. FIG. 4 shows an embodiment example, wherein undercut profiles 91 have been implemented on the walls, and cavities 92 also bordered by undercut surfaces have been implemented on the bottom of the hollow 9; the dot and dash lines show the trajectories of laser beams, passing through the recess orifice 9, and capable of machining these undercut profiles and bonding surfaces

In a fourth step 400, at least one hollow 9 is filled with this second material, which is a composite material including in part or in whole at least one bio-sourced charged polymer, which is chosen for the wear resistance thereof, to constitute an insert 2 forming such a decor 5.

In particular, this bio-sourced charged polymer can be or include a bioceramic, such as Swatch® Bioceramic®, which includes a ceramic with bio-sourced material produced from castor oil.

In a fifth step 500, surface finishing of this insert 2 is performed, by machining the surface 12 thereof, particularly recessed or flush with the surface 11 of the body 1 around the hollow 9.

More specifically, during the second step 200 and/or the third step 300, micro-reliefs 91, 92 are created, at the walls and/or bottom.

More specifically, during the second step 200 and/or the third step 300, micro-reliefs 91, 92 are created, which are undercut at the walls and/or bottom. Particularly an inclined laser shot makes it possible, even if the hollow includes a small opening, to produce such hollowed profiles in the walls or the bottom, facilitating the bonding of the second material on the first material.

More specifically, during the second step 200 and/or the third step 300, the walls and/or the bottom of the hollow are produced with a roughness between 7 and 13 micrometres Ra, more specifically between 8 and 10 micrometres Ra.

More specifically, during the fifth step 500, the insert 2 is made flush, or is machined recessed from the body 1, to limit the volume thereof to that of the hollow 9 wherein it was formed, so as to only leave second material in the hollow part of this hollow 9. Thus, the insert 2 made of the second material does not protrude from the surface of the body, where a hollow has been produced.

More specifically, said hard material of the body is chosen from an oxide, or a carbide or a nitride, respectively of titanium, or of zirconium, or of silicon, or of aluminium.

More specifically, said hard material of said body is chosen from a cermet, a sapphire, a spinel, or according to a composition taken from MgAlO4, Mn3O4, ZnFeO4, FeCrO4, LiMnO4, MgSe0.1-0.4Al0.9-0.6O4, YAG, or from precious, semi-precious stones, or hardstones, meteorites, mother-of-pearl, fossils, and similar.

More specifically, a cermet including an oxide, or a carbine or a nitride, respectively of titanium, or of zirconium, or of silicon, or of aluminium is chosen as a hard material.

In a variant, a composite ceramic is chosen as second composite material.

More specifically, this second composite material is chosen including ceramic particles.

More specifically, the second composite material is chosen including ceramic particles which are formed from an oxide or a carbide or a nitride, respectively of titanium, or of zirconium, or of silicon, or of aluminium.

More specifically, the second material is chosen including between 50% and 85% by mass of ceramic.

In a variant, this second composite material is chosen including particles of a third material which is a hard material.

More specifically, the second material is chosen including between 50% and 85% by mass of metal.

In particular, the metallic filler can include titanium, tungsten, platinum, gold, iridium.

More specifically, as second material, a material is chosen including, by mass and for a total of 100%, a filler made of a bio-sourced and/or metallic and/or ceramic material according to a percentage between 50% and 85% inclusive, at least one polymer according to a percentage between 15% and 50% inclusive, a coupling agent according to a percentage between 0% and 10% inclusive, a reinforcement according to a percentage between 0% and 10% inclusive, a pigment according to a percentage between 0% and 5% inclusive, a diluent and/or a plasticising agent according to a percentage between 0% and 5% inclusive, this polymer being bonded to this filler and/or, when the second material includes at least one coupling agent, this coupling agent being respectively bonded to the filler by one or more of the bonds chosen from a hydrogen bond, a coordination bond and an ionic bond.

More specifically, this polymer includes a hydrogen bond donor, the optional coupling agent includes a hydrogen bond donor.

More specifically, this polymer is a polyamide, and the optional coupling agent is a polyurethane.

More specifically, this polymer is a polyurethane.

More specifically, this polymer is a polyester, and the optional coupling agent is a hydroxysilane with an amide or amine function.

More specifically, the second material includes a reinforcement formed of glass fibres, and/or glass beads, and/or carbon fibres, and/or aramid fibres, and/or plant or/and animal fibres.

More specifically, during the fourth step 400, the hollow is filled with an organic matrix charged at least partially with organic particles.

More specifically again, between the fourth step 400 and the fifth step 500, an intermediate step 450 is performed, during which this organic matrix is crosslinked and densified in a controlled atmosphere, at a temperature between 20° C. and 300° C.

More specifically, this intermediate step 450 is performed at a pressure between 300 and 650 bar, more specifically between 400 and 600 bar.

More specifically, this organic matrix is formed from an optionally modified epoxide, and/or an optionally modified acrylic, and/or a polyurethane, and/or a silicone. More specifically, this organic polymer matrix is charged with ceramic; more specifically, the ceramic filler is, by mass, between 55% and 65%, inclusive, of the mass of the second material, particularly close to 60%, more specifically between 58% and 62%, inclusive.

More specifically, the first step 100 is performed by sintering.

More specifically, the second step 200 and/or the third step 300 is performed by laser scanning. Embodiment by mechanical etching is possible, but the cost of the diamond tools required is high.

More specifically, during the second step 200, the hollow is produced with a depth between 80 micrometres and 500 micrometres with respect to the top surface of the body made of hard material.

More specifically, during the second step 200 or/and third step 300, cavities or grooves are produced in the bottom and/or walls of the hollow, the depth of which is less than one fifth of this hollow.

More specifically, at least a portion of the third step 300 is performed by sand-blasting.

More specifically, between the third step 300 and the fourth step 400, during another intermediate step 350, a bonding layer is formed at the bottom and/or walls of the hollow to ensure better bonding of the second material.

More specifically, for this bonding layer, a lacquer, or a layer including at least one metal and/or a metal alloy is chosen.

More specifically, for this bonding layer, a layer including at least a metal nitride, or/and a metal carbide, or/and a silane, or/and a organosiloxane, or/and an alkanethiol, or/and a disulphide alkane, or/and a zirconate, or/and a titanate, or/and an aluminate.

In an alternative embodiment, at least a portion of fourth step 400 is performed by overmoulding or injection.

According to the choice of the first material and second material, at least one step of sintering, curing, or passage in a particular atmosphere, can be incorporated in the process.

More specifically, the first material and/or the second material is chosen including more than 75% by mass of gold and/or platinum. Under certain mass distribution conditions, a titratable component can thus be obtained.

In an alternative embodiment, the first step 100 and/or the fourth step 400 is performed by 3D printing based on a three-dimensional file.

To thus produce an object, here the body 1 or/and the insert 2, a set of three-dimensional data defining a model, which includes at least one hollow 9, and at least one discharge orifice required for the implementation of the process, is generated beforehand. This three-dimensional data set is converted into a plurality of layers, each layer representing a transverse layer of the object, said object being formed layer by layer from a powder material using an additive manufacturing process such as Direct Metal Laser Sintering (DMLS), or similar in order to produce this object in a unitary fashion. The loose powder is removed from each cavity, particularly from each hollow, via at least one such powder discharge orifice, formed between the cavity and an outer surface of the object. If required, at least one through orifice formed through the object is machined to receive a control organ or similar, this through orifice optionally being pre-formed during the three-dimensional construction of the object.

More specifically, the first step 100, the second step 200, and the third step 300 are combined in a single 3D printing operation, based on a three-dimensional file, to make the body 1 in the first material. More specifically again, at least one insert 2 is produced during the fourth step 400 performed by 3D printing with the second material, on the base consisting of the body 1.

In another 3D printing alterative embodiment, the first step 100, the second step 200, and the third step 300 and the fourth step 400 are combined in a single 3D printing operation, based on a three-dimensional file. The three-dimensional data set defines the supply of powders corresponding to the first material and the second material, and the machine programme defines the laser sintering time sequences of the first material and the second material respectively, at each relevant location.

The composite inlaying process uses petroleum-based polymers, the mechanical properties of which are superior to those of other polymers, but are at the limits with respect to scratch resistance. The mechanical behaviour of a second material made of charged plastic is superior, and preferable for a horological application, over a second epoxy-based material with a 60% ceramic filler.

In sum, the invention makes it possible to produce an element made of hard material, inlaid with at least one composite ceramic decoration with a composition including a bio-sourced matrix.

The overmoulding inlaying process is more suitable for polymers with a base including a hydrogen bond donor such as epoxide, acrylic, polyurethane or silicone. Such a composite is developed for injection technologies, which facilitates integration in a production cycle.

The choice of a polymer obtained from a biological base renders the process more economical and more environmentally friendly than previously known processes. This process is capable of automation, which differs from prior inclusions of lacquers or similar, and it is thus possible to ensure very good repeatability, at the same time as a speed of implementation.

The durability is good, and it is possible to produce a component of an acceptable hardness, with a good wear resistance.

The invention furthermore relates to a horological or jewellery external part element 10, including a body 1 made of hard material, inlaid with at least one decoration 5 made of a second material different from the hard material, particularly produced via this process. More specifically, at least one such decoration 5 consists of the surface of an insert 2 made of bio-sourced charged polymer chosen for the wear resistance thereof.

The invention furthermore relates to a timepiece or piece of jewellery 100 including at least one such external part element 10.

The invention lends itself well to the embodiment of complex decorations, or very fine decorations, such as digits, indexes, or other symbols, as well as to the embodiment of thin-walled partitioned decorations. The process also makes it possible to produce three-dimensional pieces of substantial height with respect to the dimensions of the base thereof.

1. A process for manufacturing a horological or jewellery element, made of hard material, inlaid with at least one decoration made of a second material different from said hard material, wherein in a first step, a body made of a said hard material is formed, in that, during said first step or in a successive second step, at least one hollow is produced in a face of said body made of hard material, said hollow being arranged to form the impression of a said decoration, in a third step, the surface condition of the bottom and/or walls of said hollow is modified to increase the contact area thereof, in a fourth step, at least one said hollow of said second material which is a composite material including in part or in whole at least one bio-sourced charged polymer chosen for the wear resistance thereof, to constitute an insert forming a second decoration, in a fifth step, a surface finishing of said insert is performed.

2. The process according to claim 1, wherein, during said second step and/or said third step, micro-reliefs are created at said walls.

3. The process according to claim 1, wherein, during said fifth step, said insert is made flush to limit the volume thereof to that of said hollow wherein it was formed, so as to only leave said second material in the hollow portion of said hollow.

4. The process according to claim 1, wherein said hard material of said body is chosen from an oxide, or a carbide or a nitride, respectively of titanium, or of zirconium, or of silicon, or of aluminium.

5. The process according to claim 1, wherein said hard material of said body is chosen from a cermet, a sapphire, a spinel, or according to a composition taken from MgA1O4, Mn3O4, ZnFeO4, FeCrO4, LiMnO4, MgSe0.1-0.4Al0.9-0.6O4, YAG.

6. The process according to claim 5, wherein a cermet including an oxide, or a carbide or a nitride, respectively of titanium, or of zirconium, or of silicon, or of aluminium, is chosen as said hard material.

7. The process according to claim 1, wherein a composite ceramic is chosen as second composite material.

8. The process according to claim 7, wherein said composite ceramic is chosen including ceramic particles which are formed from an oxide or a carbide or a nitride, respectively of titanium, or of zirconium, or of silicon, or of aluminium.

9. The process according to claim 7, wherein said second material is chosen including between 50% and 85% by mass of ceramic.

10. The process according to claim 1, wherein said second composite material is chosen including particles of a third material which is a hard material.

11. The process according to claim 10, wherein said second material is chosen including between 50% and 85% by mass of metal.

12. The process, according to claim 1, wherein, as second material, a material is chosen including, by mass and for a total of 100%, a filler made of a bio-sourced and/or metallic and/or ceramic material according to a percentage between 50% and 85% inclusive, at least one polymer according to a percentage between 15% and 50% inclusive, a coupling agent according to a percentage between 0% and 10% inclusive, a reinforcement according to a percentage between 0% and 10% inclusive, a pigment according to a percentage between 0% and 5% inclusive, a diluent and/or a plasticising agent according to a percentage between 0% and 5% inclusive, said polymer being bonded to said filler and/or, when said second material includes at least one coupling agent, said coupling agent being respectively bonded to said polymer and to said filler by one or more of the bonds chosen from a hydrogen bond, a coordination bond and an ionic bond.

13. The process according to claim 12,
wherein said polymer includes a hydrogen bond donor, and in that said optional coupling agent includes a hydrogen bond donor.

14. The process according to claim 12, wherein said polymer is a polyamide and in that said optional coupling agent is a polyurethane.

15. The process according to claim 12, wherein said polymer is a polyurethane.

16. The process according to claim 12, wherein said polymer is a polyester and in that said optional coupling agent is a hydroxysilane with an amide or amine function.

17. The process according to claim 1, wherein said fourth step is performed by injecting said second material into at least one said hollow.

18. The process according to claim 1, wherein said first step and/or said fourth step is/are performed by 3D printing based on a three-dimensional file.

19. The process according to claim 1, wherein said first step, said second step, and said fourth step are combined in a single 3D printing operation, based on a three-dimensional file.

20. A horological or jewellery external part element, including a body made of hard material, inlaid with at least one decoration made of a second material different from said hard material, wherein at least one said decoration consists of the surface of an insert made of bio-sourced charged polymer chosen for the wear resistance thereof.

21. A timepiece or piece of jewellery including at least one external part element according to claim 20.
